(19) United States
(12) Patent Application Publication
(10) Pub. No.: US 2015/0046298 A1
(43) Pub. Date: Feb. 12, 2015

(54) METHOD AND SYSTEM FOR MONITORING DELIVERIES

(71) Applicant: AIR PRODUCTS AND CHEMICALS, INC., Allentown, PA (US)

(72) Inventors: Michele ZWAKHALS, Cheshire (GB); William C. KEIRSTEAD, Blandon, PA (US); Jeffrey J. RIEGEL, Macungie, PA (US); Scott Lee HOWER, Macungie, PA (US); Valerie Kaye JANI, Boyertown, PA (US)

(73) Assignee: AIR PRODUCTS AND CHEMICALS, INC., Allentown, PA (US)

(21) Appl. No.: 13/963,527

(22) Filed: Aug. 9, 2013

(51) Int. Cl. G06Q 10/08

(52) U.S. Cl. CPC G06Q 10/087
USPC 705/28

(57) ABSTRACT

A system and method for monitoring deliveries includes receiving delivery information transmitted in real-time during a delivery, which information indicates an amount of a product that was delivered. A database is updated to reflect the amount of the product that was delivered according to the received information. A system and method for monitoring deliveries includes receiving information identifying a storage container, and comparing the information to stored information associated with a storage container assigned to a delivery to determine whether the identified storage container matches the storage container assigned to the delivery. A system and method for monitoring deliveries includes receiving output of a first sensor in a storage container and receiving output of a second sensor in a delivery vehicle from which the product is transferred into the storage container. Delivery amounts indicated by the respective outputs of the first sensor and the second sensor are compared.

### FIELD OF THE INVENTION

The present invention relates to a method and a system for monitoring deliveries of products. The products may be packaged in discrete containers or delivered in bulk by transferring the product into a storage container at a delivery site. The products may also be discrete pieces of equipment.

### BACKGROUND INFORMATION

Delivery of products can be logistically challenging because unforeseen problems can arise, which may require an adjustment to a delivery route or an amount of product actually delivered. For example, the product may be undeliverable because of damage or spoilage. In other instances, the wrong product or the wrong quantity of product is sent to the recipient. In still other instances, the product cannot be delivered, e.g., because the product is sent to the wrong address or the recipient is not present to receive the product.

There exist scheduling systems that generate schedules for delivery agents, e.g., truck drivers. However, these conventional systems are limited in their ability to adapt to unforeseen problems such as those mentioned above. Delivery agents will typically receive their schedules at the beginning of a business day or work shift, and then attempt to follow the schedule as closely as possible. The agents are given little if any additional guidance as to how to proceed with deliveries when problems arise. The agents are also limited in the amount of autonomy they have, e.g., with regard to where to send excess product, because the conventional systems do not allow for significant schedule deviations and/or do not provide guidance as to what locations are suitable for adding to a delivery trip.

Conventional delivery systems also allow for unacceptable levels of human error on the part of delivery agents, who are relied upon for keeping track of how much and what types of products are being transported. Inventory monitoring techniques are useful to a limited extent, for tracking product stored in a central facility such as a warehouse from which deliveries originate. However, once the product has been removed from the central facility, tracking becomes difficult, especially where the delivery agent makes many delivery stops over the course of a delivery trip. With certain types of products, it is also difficult to precisely monitor the amount of product present on a delivery vehicle at any given time. For example, gas products are typically stored in liquid form and a certain amount of product is lost through vaporization whenever the liquid is transferred in bulk, to or from a delivery vehicle. Inconsistency between a stated amount of product delivered and an actual amount of product delivered may result in the recipient receiving an incorrect bill for the delivery. In some instances, the supplier may absorb the cost by writing the inconsistency off as a loss on its balance sheets. Regardless of how the inconsistency is resolved, at least one party is adversely affected.

### BRIEF DESCRIPTION OF THE DRAWINGS

FIG. 1 is a block diagram of a system for monitoring deliveries, according to an example embodiment of the present invention.

FIG. 2 is a flowchart that shows a method for monitoring deliveries, according to an example embodiment of the present invention.

FIGS. 3 and 4 show a user interface by which a user logs into a system for monitoring deliveries, according to an example embodiment of the present invention.

FIGS. 5 and 6 show a user interface by which a user selects a trip, according to an example embodiment of the present invention.

FIG. 7 shows a user interface displaying details of a selected trip, according to an example embodiment of the present invention.

FIGS. 8 to 14 show a user interface by which a user participates in a pre-trip process, according to an example embodiment of the present invention.

FIG. 15 shows a user interface by which a user time-stamps the end of a pre-trip phase, according to an example embodiment of the present invention.

FIGS. 16 and 17 show a user interface by which a user creates a new trip, according to an example embodiment of the present invention.

FIGS. 18 to 21 show a user interface by which a user adds a stop to a trip, according to an example embodiment of the present invention.

FIG. 22 shows a user interface by which a user records a delay, according to an example embodiment of the present invention.

FIG. 23 shows a user interface by which a user records refueling stops, according to an example embodiment of the present invention.

FIG. 24 shows a user interface by which a user records vehicle load parameters, according to an example embodiment of the present invention.

FIGS. 25 to 29 show a user interface by which a user participates in a delivery process, according to an example embodiment of the present invention.

FIG. 30 shows a user interface by which a user records details of a packaged delivery, according to an example embodiment of the present invention.

FIGS. 31 to 34 show an example user interface by which a user records failed deliveries, according to an example embodiment of the present invention.

FIG. 35 shows a user interface by which a user captures and accesses stored photos, according to an example embodiment of the present invention.

FIGS. 36 to 39 are flowcharts of methods for validating delivery information, according to an example embodiment of the present invention.

FIG. 40 shows a user interface by which a user participates in a post-trip process, according to an example embodiment of the present invention.

### SUMMARY

Example embodiments of the present invention provide a system and method for monitoring delivery of a product. According to example embodiments, a system and method for monitoring delivery of a product involve receiving delivery information transmitted in real-time during a delivery. The information indicates an amount of a product that was delivered. A processor receiving the information updates a database to reflect the amount of the product that was delivered according to the received information. This allows the system to keep track of inventory based on real-time information from the field, where changes in inventory are occurring.

According to example embodiments, a system and method for monitoring delivery of a product involve at a processor of a computer, receiving information identifying a storage container. The processor compares the information to stored information associated with a storage container assigned to the delivery. Based on the comparing, the processor allows the agent to continue with the delivery. This allows the system to verify that deliveries are occurring at the correct locations, and is especially useful when the same delivery location has multiple storage containers into which product can potentially be delivered.

According to example embodiments, a system and method for creating a delivery schedule involve receiving a user request to create a schedule for a user-defined delivery trip. The schedule is created by user input of a trip starting location and a trip ending location, along with user selection of a delivery location from a list of potential delivery locations. A delivery stop is added to the schedule between the starting location and the ending location, in response to user selection of one of the potential delivery locations. This provides freedom with respect to scheduling, since the user is able to define a new schedule, and is not limited to predefined schedules that may have been created without user input.

According to example embodiments, a processor of a computer receives output of a first sensor in a storage container and output of a second sensor in a delivery vehicle. The processor grants permission to end the delivery process, depending on an outcome of a comparison between delivery amounts indicated by the respective outputs of the first sensor and the second sensor. This is useful for making sure that delivery amounts are accurately recorded at the scene of each delivery. If one of the sensors is malfunctioning, the comparison will detect this and appropriate corrective action may be taken.

### DETAILED DESCRIPTION

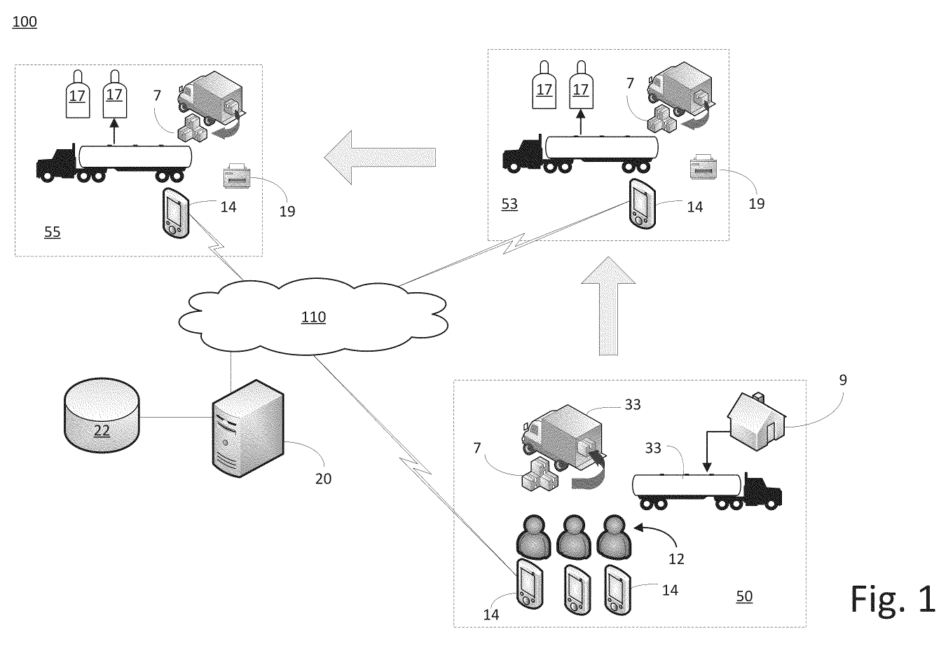

FIG. 1 shows an example system 100 for monitoring deliveries according to an example embodiment of the present invention. The system 100 may include a central computer, e.g. a server 20, that communicates with a plurality of delivery agents 12 through portable computers 14 respectively operated by the agents 12. A communication network 110 wirelessly connects the server 20 to the computers 14. In one embodiment, the network 110 is a mobile phone network (e.g., a 3G or 4G network) and the computers 14 are smartphones. The availability of wireless access varies by location, so the technology used to implement the network 110 may depend on where the system 100 is located. It may also depend on the distances over which the system is expected to communicate with the users 12 (e.g., mobile phone networks have a significantly greater range compared to Wi-Fi) and how fast the system 100 needs to communicate. Therefore, the network may be selected based on communication requirements.

The server 20 executes monitoring and scheduling algorithms that provide for the creation and adjustment of delivery schedules, along with real-time monitoring of deliveries. In an example embodiment, the server 20 also executes algorithms for performing post-delivery processes, which may include billing, inventory management, customer support, or payroll processes. Algorithms executed by the server 20 may be stored as program code on a non-transitory computer readable medium including any conventional memory device, to perform any of the methods described herein, alone or in combination, e.g., to output any one or more of the described graphical user interfaces. The memory device can include any conventional permanent and/or temporary memory circuits or combination thereof, a non-exhaustive list of which includes Random Access Memory (RAM), Read Only Memory (ROM), Compact Disks (CD), Digital Versatile Disk (DVD), and magnetic tape.

Various data pertaining to any of the server functionality herein may be stored in a database 22, including user profiles (e.g., employee records for each of the delivery agents 12), customer information, delivery schedules, inventory records, delivery records or invoices. The server 20 may access this data in support of the algorithms it executes.

Each of the computers 14 may be equipped with a display and an input arrangement (e.g., a touch screen) by which the agent 12 inputs information for transmission to the server 20. In an example embodiment, the computers 14 include a GPS receiver (e.g., an antenna and software for communicating with a GPS satellite) by which the location of the computer 14 may be calculated. The computers 14 may include a camera (built-in or externally connected) and software for transmitting images captured by the camera to the server 20. The computers 14 may also include a barcode scanner or RFID reader, and hardware or software for interaction with printers. The computers 14 may further include software that interfaces with the server 20 for performing monitoring and scheduling tasks.

In an example embodiment, delivery vehicles include on-board devices such as sensors or meters for monitoring a product stored in the vehicle, e.g., the amount of product in the vehicle by weight or by volume, product temperature, product pressure, or the amount of product loaded into or transferred from the vehicle (e.g., measured by a flowmeter). The on-board devices may also provide information relating to vehicle condition, such as fuel level or distance traveled (e.g., mileage measured by an odometer). Information from the on-board devices may be conveyed to the agent directly, e.g., visually or using audio. In an example embodiment, the computers 14 include a communication arrangement for wirelessly receiving the monitoring information from one or more of the on-board devices e.g., using Wi-Fi, Bluetooth or infrared hardware. As used throughout the specification, the term “delivery vehicle” refers to mobile delivery equipment such as trucks and vans, into which product is loaded for transport to a recipient. Delivery vehicle may also refer to equipment combinations such as a tractor in combination with a trailer.

As will be explained in connection with the example embodiments described herein, the system 100 provides for real-time monitoring of delivery activity using communications between the server 20 and the computers 14, which communications include input from the agents 12. For example, the system can monitor delivery activities occurring at a loading location 50 to obtain information about products being loaded onto a delivery vehicle 33 for delivery to one or more recipients. The products may include packaged products 7, which are stored in discrete containers (e.g., boxes or portable tanks). Alternatively or additionally, product loaded onto any particular delivery vehicle 33 may include bulk product that is transferred in volume to a storage vessel situated in the delivery vehicle. Bulk product may be dispensed from a storage facility 9 in which the product is stored, e.g., using specialized equipment and under controlled environmental conditions (temperature, pressure, humidity, etc.).

Monitoring may occur at any point during a delivery trip, including while the agent is enroute to a first delivery location 53 or a second delivery location 55, while the agent is stopped at the delivery locations 53, 55, or enroute to a designated ending location (e.g., the same loading location 50, another loading location, a vehicle repair shop or a vehicle storage facility).

Each delivery location corresponds to a scheduled stop of a delivery trip. The delivery location may be assigned to the trip prior to beginning the trip, e.g., when the delivery agent initially receives his delivery schedule. Example embodiments of the present invention also allow for stops to be added or removed from the schedule based on unforeseen circumstances or based on product availability.

Example embodiments of the present invention provide for delivery documentation to be provided to a recipient at the delivery location. In an example embodiment, each delivery agent may carry a portable printer 19, which can be attached to the computer 14 or carried separately and brought around the delivery location. Alternatively, the printer 19 may be located on-board the delivery vehicle. The printer 19 may be used to, in response to a command from the computer 14, print an initial delivery documentation in the form of a delivery receipt, which may supplement or be superseded by final documentation generated after the delivery transaction has been completely processed, e.g., at the server 20.

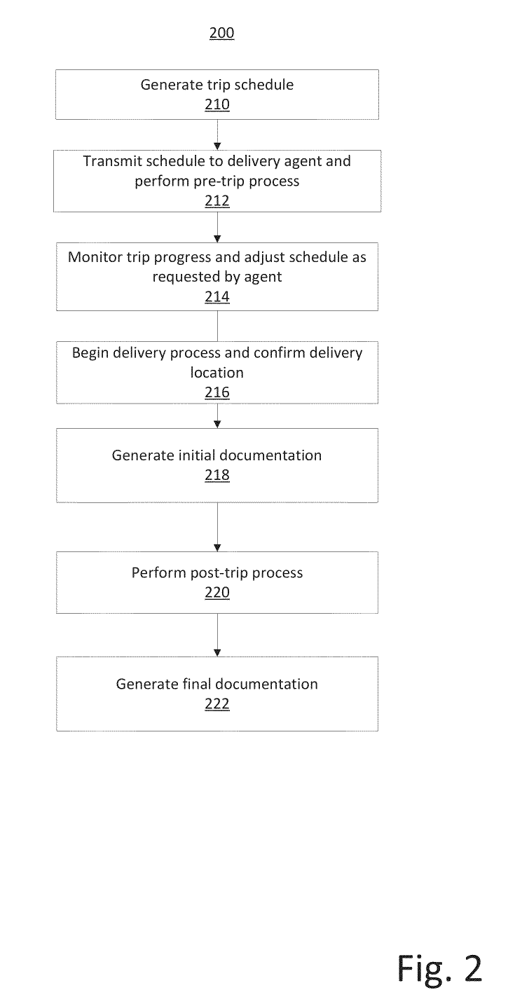

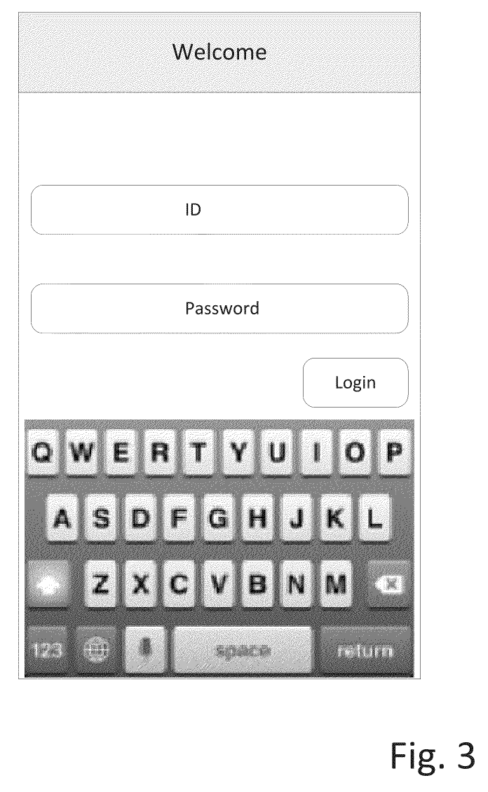

FIG. 2 is a flowchart of a method 200 for monitoring deliveries according to an example embodiment of the present invention. The method 200 will be described in connection with the system 100 and the example graphical user interfaces (GUIs) shown in FIGS. 3 to 31. At step 210, a trip schedule is generated. In an example embodiment, the schedule is generated by a scheduling algorithm at the server 20, for each agent 12. Each trip schedule includes a starting location (e.g., a loading location), at least one delivery location, and an ending location. The schedule may include expected times at which the agent is supposed to arrive at each location, in addition to delivery parameters such as what types of product to deliver, product amounts, and special delivery instructions (e.g., instructions as to how or where the product is to be delivered to a specific customer). The schedule may also specify delivery equipment for use in making the trip. In an example embodiment, a delivery fleet includes a plurality of different equipment types, such as tractors, vans and tankers. The scheduling algorithm may select equipment appropriate for the type of product being delivered.

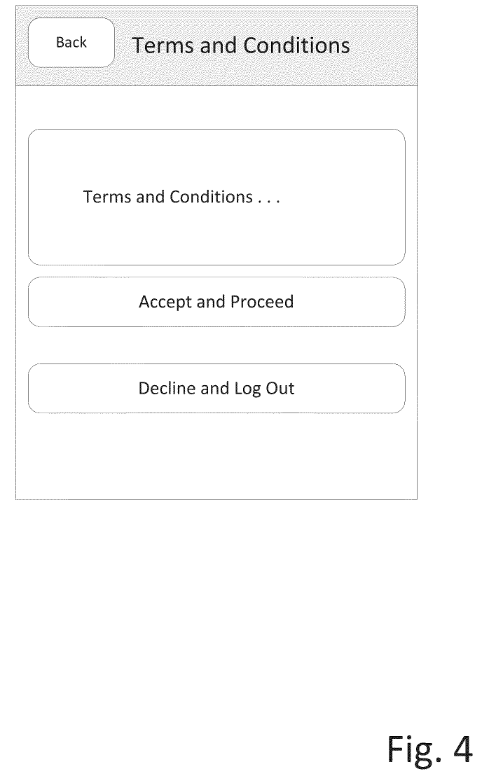

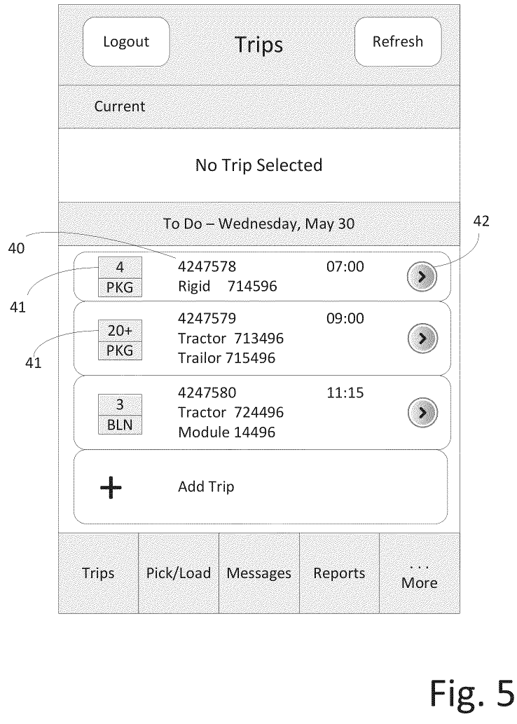

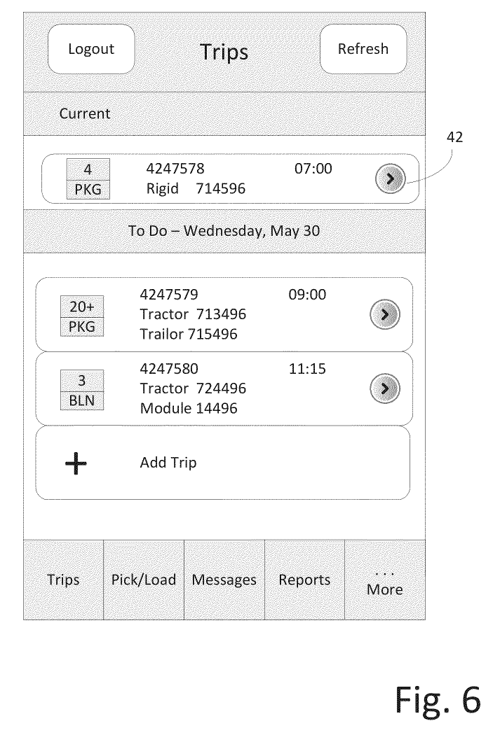

At step 212, the trip schedule is transmitted to a delivery agent and a pre-trip process is performed. In an example embodiment, agents may be required to log into the system by inputting a user ID and password into their computers 14. FIG. 3 shows an example GUI 61 in which the user ID and password are input for transmission to the server 20. The login information is verified at the server 20 by comparing the login information to stored user profiles, e.g., located in the database 22. When the login information is verified, the computer software may proceed to the example GUI 62 of FIG. 4, in which terms and conditions for use of the monitoring software are displayed. The agent is provided a choice between accepting and declining the terms and conditions. If the agent accepts, the software may obtain and display a list of trips, as shown in the example GUI 63 of FIG. 5. The list of trips forms a “to do” list and the agent may be assigned at least one trip for any given work day or shift. The agent is given an option to select one of the trips for commencement, designated as the current trip. In the example GUI 64 of FIG. 6, the agent has selected trip number “4247578” as the current trip.

The schedules for each trip may be downloaded prior to selection of the current trip. As shown in FIG. 5, this basic information may include a trip identifier 40, a vehicle type (e.g., rigid (a truck without a trailer), tractor plus trailer, or tractor plus module) along with a corresponding vehicle identifier, and an estimated beginning time. In an example embodiment, the GUI 63 provides graphical indications of the general nature of the trip, in the form of graphical icons 41. Each icon 41 may include a first part indicating the quantity of product to be shipped, and a second part indicating the type of product. Example products include a packaged product (PKG) and bulk nitrogen (BLN). Each trip generally involves a single type of product, and therefore a single icon. The icons 41 provide a convenient way for agents to quickly determine the workload involved in each trip.

In an example embodiment, the GUI 63 includes an option to add a trip. As will be explained in further detail, the system 100 may provide agents with a large degree of autonomy with respect to managing their own schedule. This includes adding entire trips, and may further include modifying existing trips, e.g., to include additional delivery stops. In regard to the addition of trips, one embodiment provides for the creation of what are known as “milk runs,” in which the agent proceeds to a designed location, whereupon arrival the agent determines whether the recipient requires delivery of product, and whether the recipient has empty product containers that need to be picked up.

The example GUIs shown in the figures may include a navigation menu, generally located at the bottom of the screen. In FIG. 5, the navigation menu includes options to select sub-menus relating to the agent's work day, e.g., returning to the list of trips shown in the GUI 63, picking a delivery vehicle and loading product into the vehicle, reviewing messages transmitted from the server 20, and filing a vehicle incident report. These options correspond to common delivery related activities. The GUIs may include further menu options, e.g., at the top of the screen, to return to a previous menu, to execute an action (e.g., saving user input information) or to cancel an action.

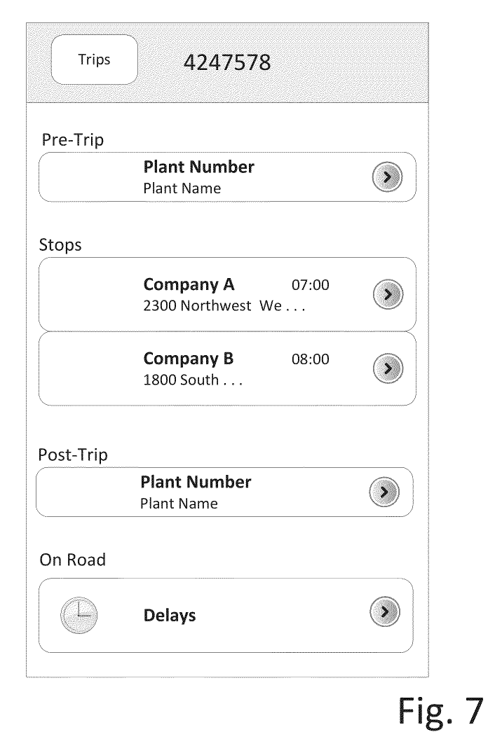

The GUIs may include buttons to initiate a software action associated with a menu option. In an example embodiment, these buttons are graphically represented as chevron icons 42. In FIG. 5, activating the chevron for any particular trip may designate the associated trip as the current trip. Alternatively, the activation may display a sub-menu with detailed information for the associated trip, from which sub-menu the associated trip may be designated as the current trip. In FIG. 6, activating the chevron for the current trip displays the detailed information shown in the example GUI 65 of FIG. 7.

In an example embodiment, trips are divided into three phases: a pre-trip phase, a stop phase including one or more delivery stops, and a post-trip phase. The GUI 65 shows an overview for each of these phases. On activation of the associated chevron icons, the GUI may transition to sub-menus for each phase. The GUI 65 may also include an option to access a sub-menu relating to delays incurred during the trip. Overview information for the pre-trip information may include the starting location, e.g., the name of a plant that serves as the loading facility from which product is loaded onto the delivery vehicle. Overview information for stops may include the name and address of at least one recipient, along with a scheduled delivery time (e.g., planned arrival time) for each recipient. Overview information for the post-trip phase may include an ending location, e.g., the name of a plant that serves as the unloading facility to which the delivery vehicle is returned for unloading remaining product.

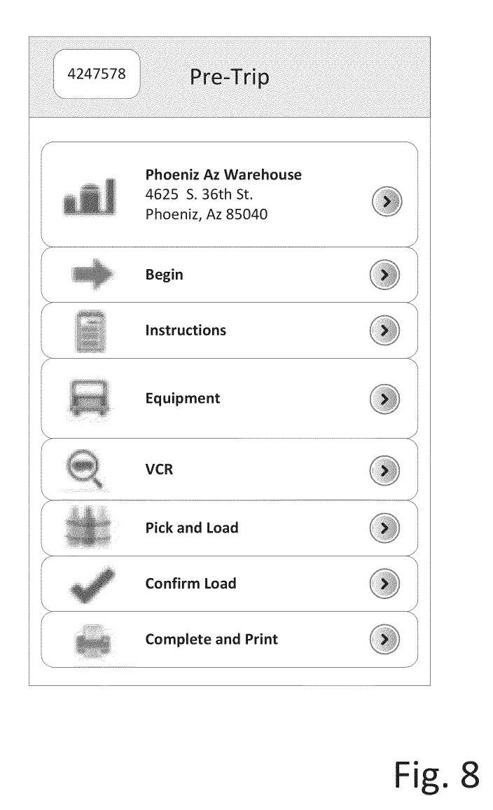

FIG. 8 shows an example GUI 66 that provides menu options relating to a pre-trip process for the current trip (trip number 4247568). The options may include options to access details concerning the starting location, special delivery instructions, select equipment (e.g., the delivery vehicle), create a vehicle condition report (VCR), pick and load a product into a vehicle, confirm loading, and to complete the pre-trip process (including an option to print a pre-trip confirmation). In an example embodiment, these options are not made available all at once. Instead, options that correspond to activities that logically occur later in the pre-trip process may not be made available until earlier options are selected. For example, upon selection of the “Begin” option, the software makes the “Instructions” option available along with a visual indication of availability (e.g., changing the display of the Instructions option from gray to color). Selection of the Instructions option results in a transition to a screen showing special delivery instructions, if any, and upon returning to the pre-trip menu, the “Equipment” option becomes available. The GUI 66 may step through each remaining option in a similar fashion, guiding the agent through the various sub-menus associated with these options to ensure that the agent does not skip any important steps in the pre-trip process. The software may similarly guide the agent through options in other GUIs.

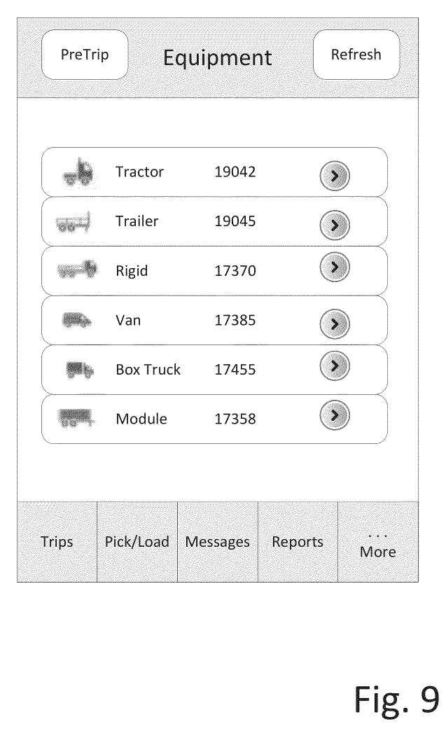

FIG. 9 shows an example GUI 67 that provides options to select from a list of available equipment. Each item of equipment may be assigned an identifier. Example equipment includes delivery vehicles (tractors, rigid trucks, vans, box trucks, etc.) and storage vessels that can be paired with the delivery vehicles (e.g., general-purpose trailers or module trailers). The server 20 may track the equipment assigned to each trip location and transmit that information to the computers 14. The agent may select one or more of the available equipment for use during the trip.

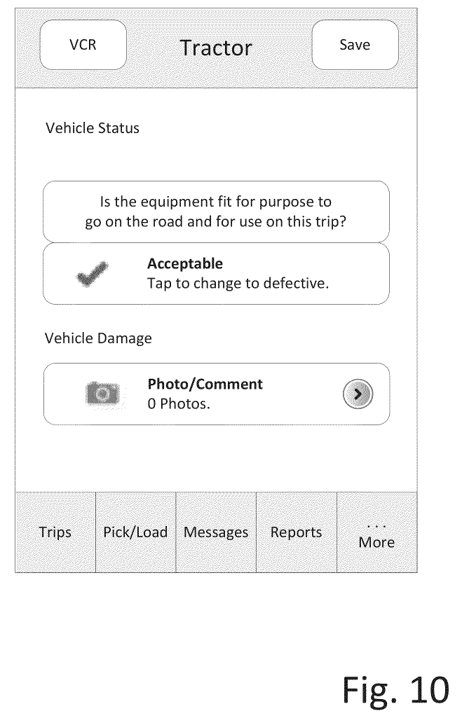

FIG. 10 shows an example GUI 68 that provides a sub-menu for the VCR option in FIG. 8. The GUI 68 includes an option for the agent to indicate whether the equipment selected using the Equipment option is fit for the purpose of going on the road and for use on the current trip. In some instances, the agent may have selected equipment, only to later discover, e.g., upon visual inspection, that there is a problem that makes the equipment unsuitable for the current trip. In response to receiving an indication that the equipment is unsuitable, the software may allow the agent to select substitute equipment from the list of available equipment, then communicate the change in selection to the server 20. The GUI 68 may also include an option to document vehicle damage, e.g., with agent input of text describing the damage or with an image captured using the camera.

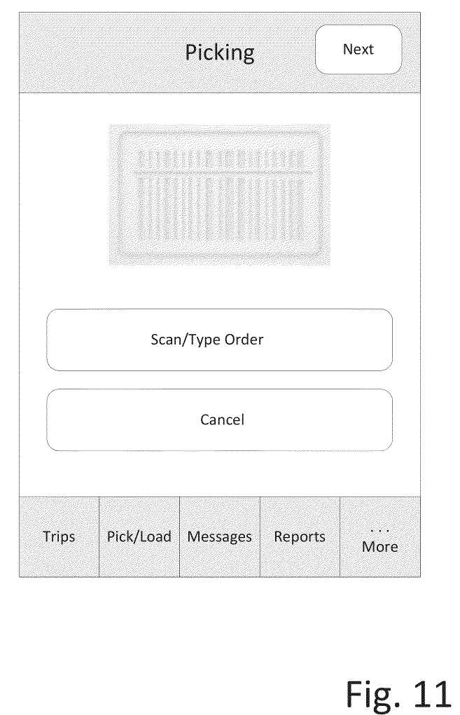

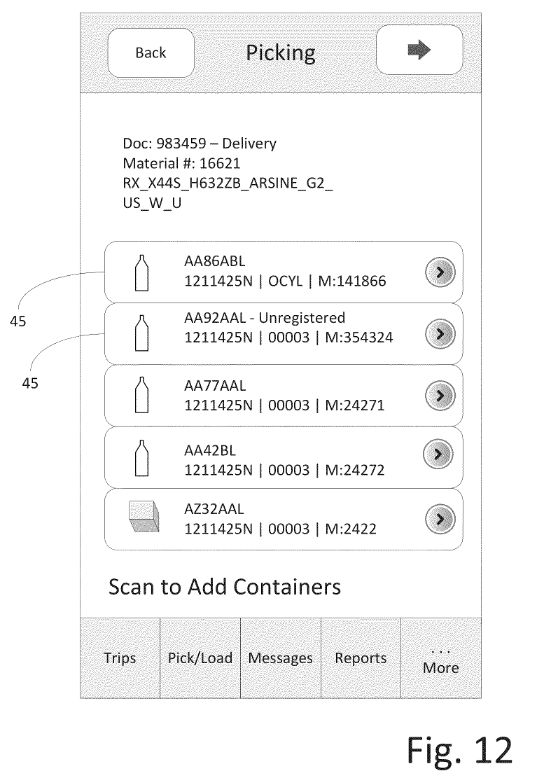

FIG. 11 shows an example GUI 69 that provides a sub-menu for the “Pick/Load” option in FIG. 8. The GUI 69 includes an option to manually add product to a list of products loaded onto the selected equipment, e.g., by scanning an electronic tag, such as a barcode, associated with a customer order or manually typing in an order number (“983459” in FIG. 12). In many instances, the order is already in the system. During the scheduling process the server 20 may have determined that there is an outstanding order to deliver product to a recipient at a delivery location associated with the scheduled trip. The server 20 may transmit a list of products to be delivered for fulfilling the order, which list is then displayed at the computer 14. The agent, upon viewing the product list, will locate and transfer the required product(s) to the delivery vehicle.

If the product list includes a packaged product, the software may transition to a container view, as shown in the example GUI 70 of FIG. 12. The container view shows a list of containers (packages in this instance) 45 that have been loaded. The container view may include a separate screen for each product. For example, the GUI 70 is specific to containers 45 relating to an Arsine gas product, which product is identified by a material number “16621”.

Each package loaded onto the delivery vehicle may be scanned. In an example embodiment, barcode labels are applied to packaged products and each label includes a human-readable representation of the barcode (e.g., an alphanumeric code). The agent may scan the barcode using a barcode scanner or manually input the human-readable representation into the computer 14. In an example embodiment, the camera is used, in replacement of a conventional barcode scanner, to capture an image of the barcode. The computer software processes the image to transmit the barcode information to the server 20, which updates the product inventory to reflect the scanning.

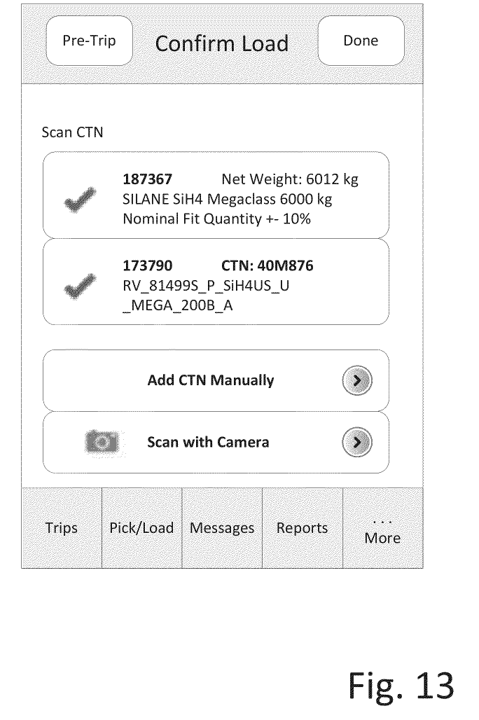

The computer 14 may request a confirmation from the agent that all required products have been loaded (e.g., the “Confirm Load” option in FIG. 8). The confirmation may include selection of a “Done” option in the GUI 17 of FIG. 13. As each product is loaded, the server 20 may check the product's identifier against the order to determine whether the product matches the order. If the product does not match, the server 20 may cause the computer 14 to display an error message. Alternatively, the server 20 may delay the checking until the agent attempts to confirm the load, whereupon the entire list of loaded products is checked against the order.

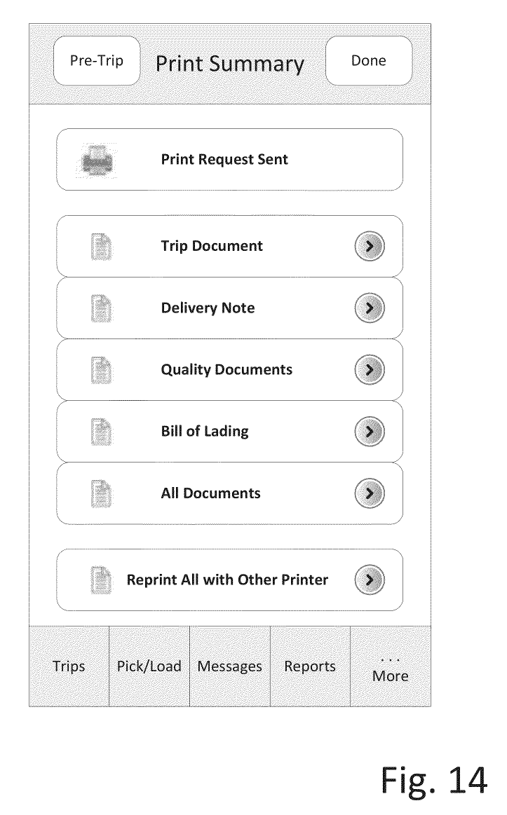

FIG. 14 shows an example GUI 72 that provides a sub-menu for the “Complete and Print” option in FIG. 8. The GUI 72 provides an option to print all the pre-trip documents, e.g., using a printer located at the loading facility. Pre-trip documents may include a trip document summarizing the trip, a delivery note containing special instructions for the agent, quality documents describing the quality of the loaded products, and a bill of lading. The print request may be wirelessly transmitted directly to the printer, or through the network 110. The GUI 72 includes options to print each pre-trip document individually. In an example embodiment, printing defaults to the portable printer 19, but there may be other printers that the computer 14 communicates with. Accordingly, the GUI 72 includes an option to reprint all of the pre-trip documents using another printer.

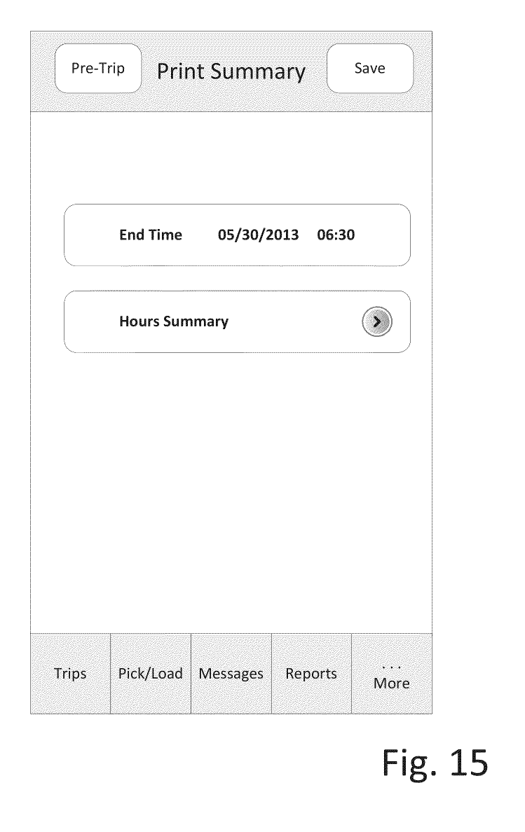

In an example embodiment, each phase (pre-trip, stop, post-trip) may be time-stamped by recording a start time and/or an end time of the phase. The time-stamping can be automatically performed using a software implemented clock at the computer 14. Alternatively, the agent can manually enter each start/end time, e.g., based on the time indicated by the software clock. The time-stamping facilitates delivery monitoring by providing the server 20 with an indication of how the trip is progressing. The time-stamping is also useful during post-trip processing, for generating billing documentation. FIG. 15 shows an example GUI 73 in which a time-stamping menu is provided for the pre-trip phase. In this menu, the agent has specified a pre-trip end time and is provided with an option to view a time summary, e.g., a total number of hours spent on the trip to-date.

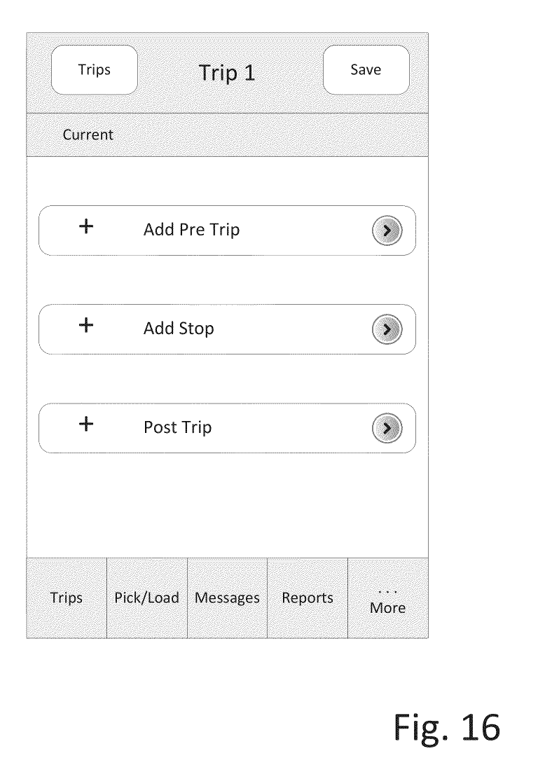

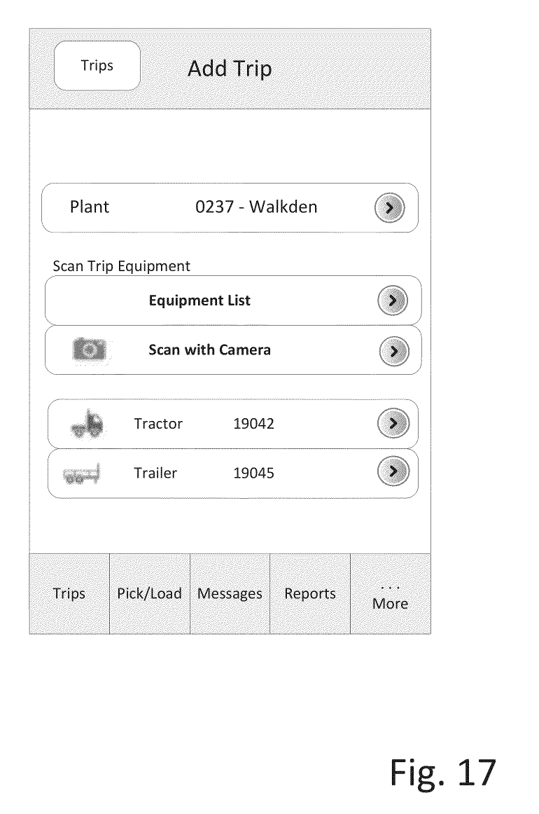

As mentioned earlier, the system 100 may provide agents with a large degree of autonomy with respect to managing their own schedule. For example, by selecting the “Add Trip” option in FIG. 5, the agent may cause the software to transition to the example GUI 74 of FIG. 16. The newly created trip is illustratively labeled “Trip 1”, but the actual trip identifier may be assigned by the server 20. The agent is provided with options to access sub-menus for defining the pre-trip phase of the new trip, add stops to the new trip, and define a post-trip phase of the new trip. The pre-trip may be defined by selecting a starting location (e.g., from a list of loading facilities), a pre-trip start time, selecting equipment, selecting a pre-existing order or inputting a new order, and other actions previously described in connection with the pre-trip phase. For example, in FIG. 17 the example GUI 75 shows that the “Walkden” plant has been selected as the starting location, and the delivery equipment includes tractor “19042” and trailer “19045”. The post-trip phase will be described in further detail below, and may be defined by selecting an ending location and a post-trip start time and/or a post-trip end time. Although the addition of trips has been described as occurring during the pre-trip phase, in an example embodiment, trips can be added any time, using menus similar to the GUIs 74, 75.

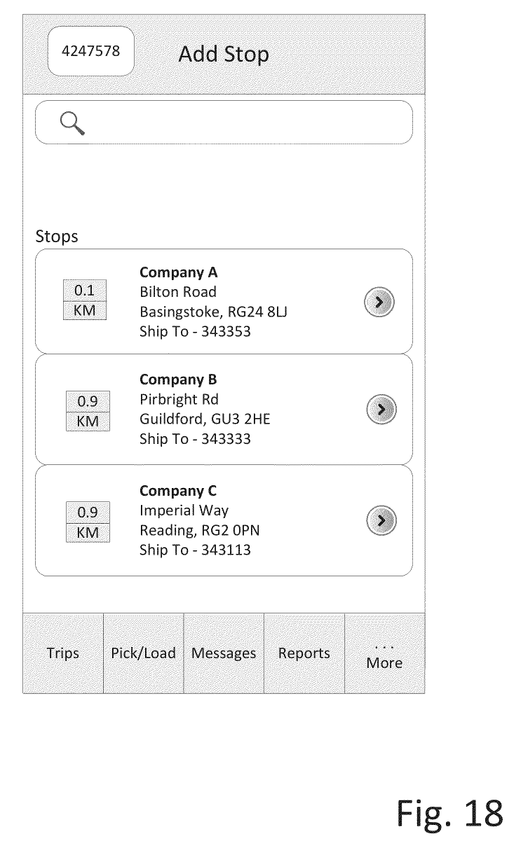

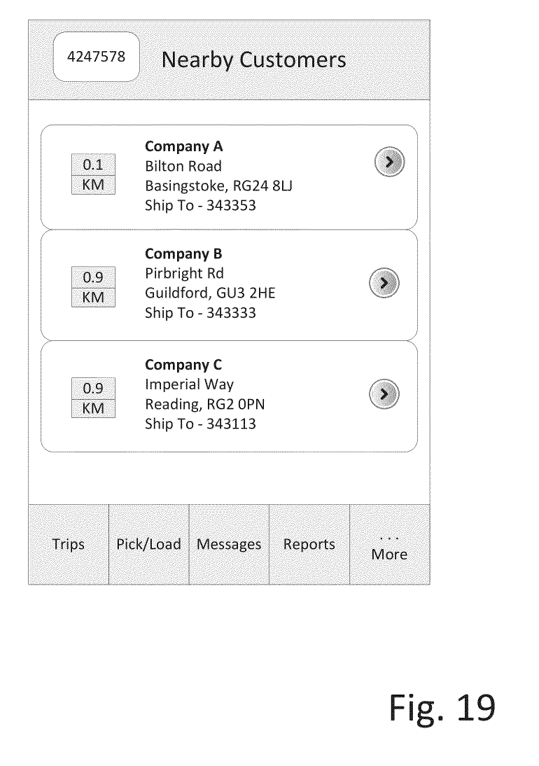

Referring back to FIG. 2, after step 212, the pre-trip phase is complete and the trip is now in-progress. At step 214, the server 20 monitors the progress and may adjust the schedule as requested by the agent. In an example embodiment, the system 100 allows agents to adjust the trip schedule by adding stops to a trip, e.g., to the current trip or to another trip assigned to the agent. The example GUI 76 of FIG. 18 provides a menu by which the agent can add a stop to the trip “4247578” by selecting from a list of potential delivery destinations. The GUI 76 includes a text field for receiving agent input of a search parameter (e.g., a customer name or address). The computer 14 generates a list of matching destinations for display in the GUI 76. Each potential destination may be displayed with the name of the recipient (e.g., a company name), an address, and a distance of the destination. The software may be configurable to display different types of distances for each destination in the alternative or simultaneously, including a distance from the current location of the agent (e.g., where the computer 14 includes a GPS receiver), a distance from a current stop, a distance to the next stop after the current stop, a distance from a trip starting location, and a distance from a trip ending location. These distances may be calculated at the computer 14 based on stored location information such as GPS coordinates for each potential destination. The computer 14 may also generate a list of nearby destinations for display without requiring input of a search parameter, as shown in the example GUI 77 of FIG. 19. The computer 14 may perform the search with or without the aid of the server 20.

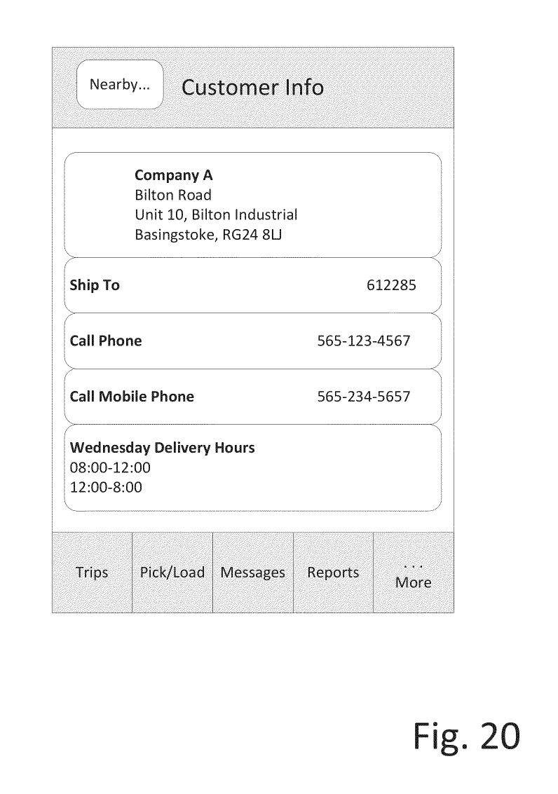

The software may provide for display of detailed information for each potential destination, the information being transmitted from the server 20. FIG. 20 shows an example GUI 78 that displays an example of such detailed information, which may include a “ship to” number that identifies the recipient's location (the ship-to number is typically associated with the recipient's address), a telephone number for contacting the recipient, and delivery times for when the recipient is available to accept deliveries.

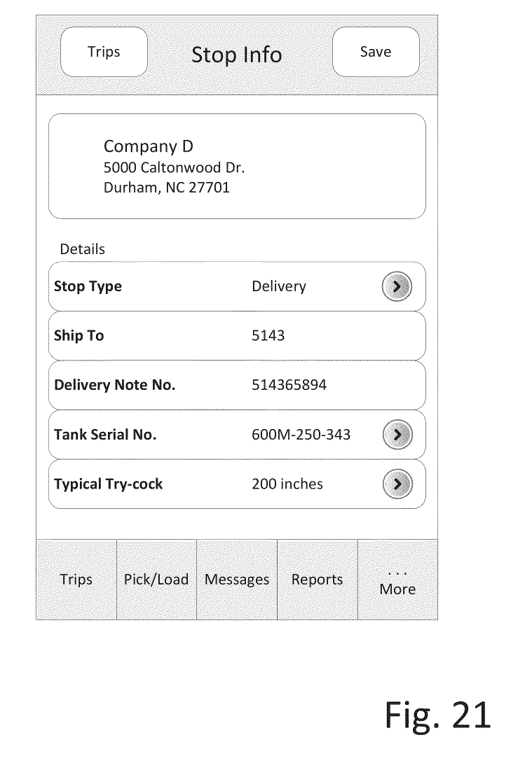

FIG. 21 shows an example GUI 79 that displays options to further define a stop after the destination has been selected. The options include specifying a stop type (e.g., whether the stop is a delivery, a container pick-up, an equipment swap, an equipment pickup, or an equipment drop), a storage container into which to transfer a bulk product (e.g., a serial number of a storage tank), and an amount to deliver (e.g., a try-cock level for a liquid in the storage tank). The system may assign a delivery note to the stop. The delivery note describes the product delivered and may be generated during the pre-trip phase. Where the stop is added after the pre-trip phase, the delivery note may be generated based on product actually delivered.

In an example embodiment, the server 20 analyzes the ability of the agent to provide complete delivery at a stop being added. The analysis may involve determining whether the delivery vehicle has enough fuel to complete the trip without refilling. The analysis may involve determining whether the delivery vehicle has a sufficient quantity of product to meet the demands of the recipient (e.g., actual demands in the case of an existing order, or expected demands in the case of a milk run), while also meeting the demands of the existing stops. Accordingly, trip monitoring may involve tracking how much fuel or product is present in the delivery vehicle at any given time. Fuel/product information may be provided to the server 20 automatically by the computer 14 and/or by sensors in the vehicle. The agent may also manually input this information using the computer 14 for transmission at various times, e.g., at the beginning and end of each stop, in connection with the time-stamping. When the server 20 determines that the fuel/product are insufficient, a warning message may be displayed on the computer 14 to indicate that it is inadvisable to add the stop. The agent may revise the stop parameters (e.g., by selecting a different customer order for the same destination or choosing a different destination). The agent may also be allowed to override the warning (e.g., where a refueling or a reloading stop has been planned, but not yet input into the system).

In an example embodiment, the system 100 provides for creation of milk runs using the previously described options to add trips and stops. Traditionally, milk runs involve a delivery agent going on a trip along a predefined route, e.g., a route routinely traveled by the agent. The delivery agent has little flexibility in deviating from the route. In contrast, milk runs created in accordance with example embodiments of the present invention may involve agent input as to where to perform a stop. Using the software on the computer 14, the agent can create a trip in which one or more (possibly all) of the stops are milk runs. The computer 14 may restrict the addition of stops based on distance or expected demand. For example, the computer 14 may prevent a stop from being added as a milk run if the expected demand associated with the stop causes the total expected demand (from all stops) to exceed the amount of product loaded onto the vehicle. With regard to distance, the computer 14 may limit the total distance traveled based on how much fuel remains in the vehicle. The computer 14 may also limit the distance between stops. If a potential destination fails to meet the distance criteria, the computer 14 may prevent the destination from being displayed in a search result or output a warning that adding the destination as a stop is inadvisable.

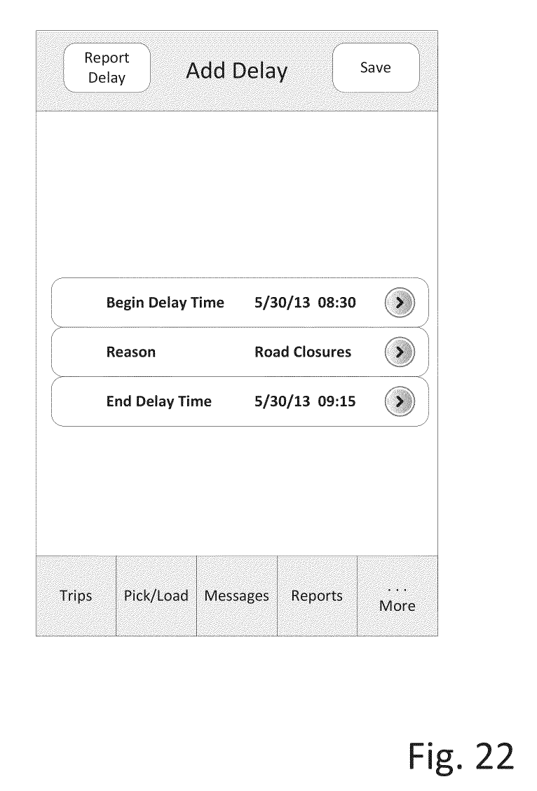

Another way in which the system 100 adjusts trip schedules is in response to travel delays. In an example embodiment, the software allows the agent to input a delay into the computer 14 for transmission to the server 20, where the schedule may be adjusted, e.g., by changing the arrival times of subsequent stops to account for the delay. The server 20 may determine whether the delay makes it impossible to perform a delivery. For example, the delay may result in the agent being unable to reach a recipient during a time window in which the recipient is available for receiving delivery. The server 20 may attempt to rearrange the stops to correct this. If it is impractical to rearrange the stops (e.g., because rearrangement would involve excess travel distance or time), the server may remove one or more stops from the agent's schedule and reassign the removed stops to another agent, e.g., an agent scheduled to be near a removed stop at around the originally planned arrival time. FIG. 22 shows an example GUI 80 by which a delay start time and a delay end time are recorded, e.g., using a software clock or manual input, as previously discussed in connection with time-stamping. The GUI 80 also includes an option to specify a reason for the delay. The software may include predefined delay reasons organized by category such as leaving the depot (i.e., the loading location), vehicle breakdown, on route holdup, and customer site. For each delay category, the software may present a list of specific reasons from which the agent may choose an appropriate reason. For example, leaving the depot may include waiting for the product to be filled, waiting for the vehicle to be loaded, driver absent or late, vehicle unavailable, and weather conditions at the depot. The on route holdup category may include weather conditions, accidents, road closures, traffic, and driver breaks. The vehicle breakdown category may include a list of each vehicle type or a list of parts for each vehicle type. The customer site category may include weather conditions, open/close times, meal breaks, meetings, security checks, and waiting for vehicle access.

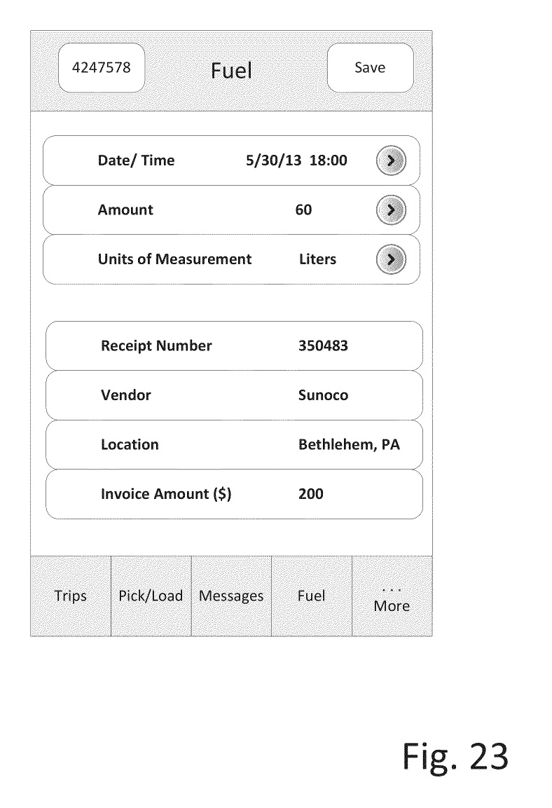

FIG. 23 shows an example GUI 81 in which refueling stops can be recorded by inputting a time, an amount of fuel added, a sales receipt number for the fuel purchase, a fuel vendor name, a location of the vendor, and the fuel cost.

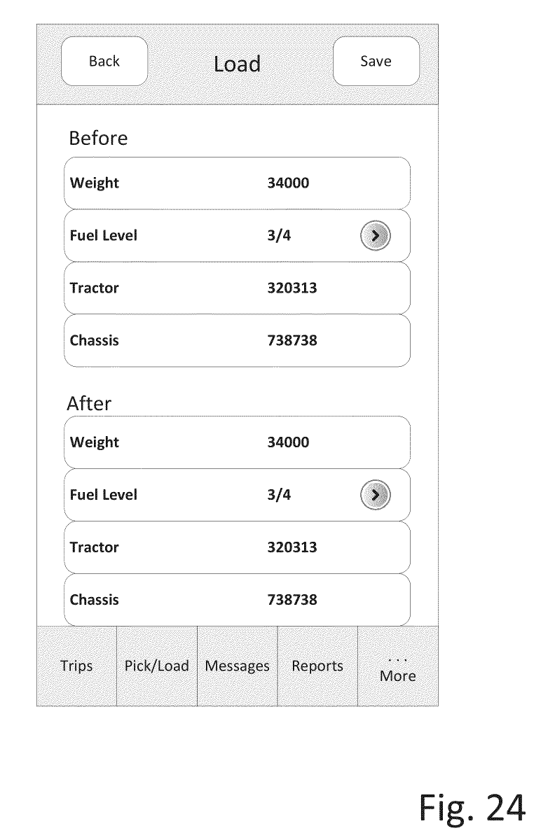

FIG. 24 shows an example GUI 82 for monitoring vehicle load. The GUI 82 may be activated whenever a change in equipment occurs (e.g., an equipment swap during a scheduled stop or when the vehicle is being loaded during the pre-trip phase). The system may record before and after parameters related to load, such as vehicle weight, fuel level, and identifiers of the delivery equipment.

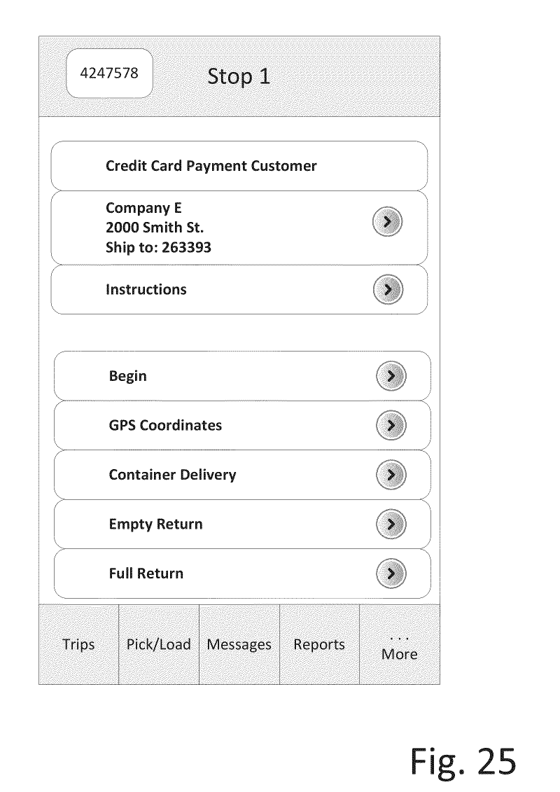

When the agent arrives at a delivery location, the method proceeds to step 216, where the computer 14 begins the delivery process in response to agent input. FIG. 25 shows an example GUI 83 in which summary information concerning the recipient is displayed along with options to access additional recipient information and special instructions. After the instructions have been accessed, the software makes available an option to begin the delivery process, starting with the obtaining of GPS coordinates. Additional stop related options such as container delivery, empty return (empty container pickup) and full return (full container pickup) may also be accessed.

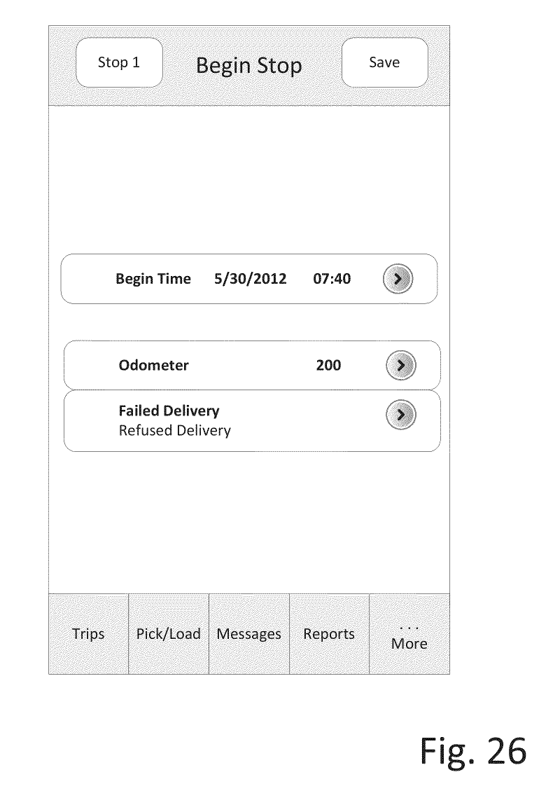

FIG. 26 shows an example GUI 84 corresponding to a menu displayed in response to selecting the “Begin” option in FIG. 25. The GUI 84 includes a time-stamp option for inputting a start time, an odometer option to record the distance traveled, and an option to indicate delivery failure.

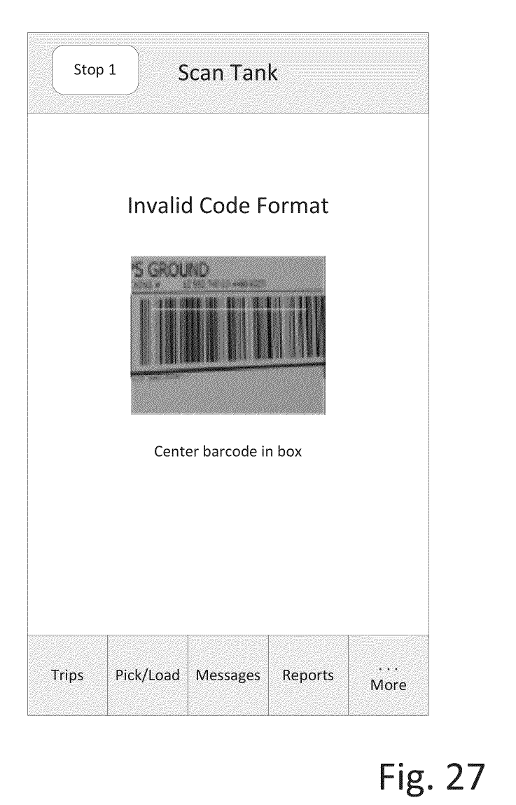

At step 216, the software confirms the delivery location by checking whether the agent is at the correct location. After the location is confirmed, the software allows the agent to access further options associated with the delivery process. If the delivery location is wrong, the further options may be disabled and a warning message displayed to the agent. In an example embodiment, the software performs the confirmation using an electronic tag (e.g., a barcode or RFID) associated with a storage container at the delivery location. Each location may have at least one tagged container to designate the location into which product is unloaded from the vehicle. Where no tag exists, the agent may apply a new tag to the storage container and input the tag information into the system for referencing during future deliveries to the same storage container. FIG. 27 shows an example GUI 85 by which an agent scans a barcode using the built-in camera of the computer 14. A menu similar to the GUI 85 may be used for scanning packaged products during loading and unloading. The software may decode the tag information and determine whether the code is valid, in which case the code is compared with a stored code associated with the recipient's order.

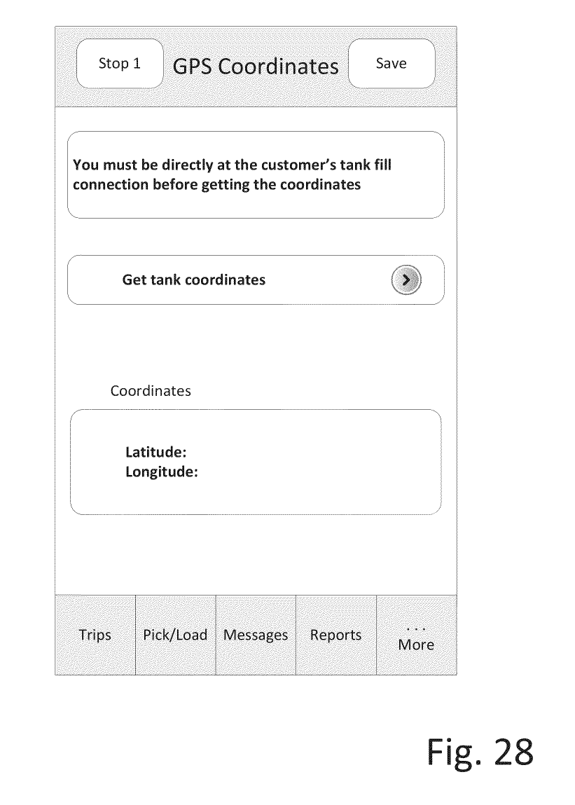

Additionally or alternatively to electronic tagging, the software may confirm the delivery location using GPS. FIG. 28 shows an example GUI 86 by which GPS coordinates are obtained using the GPS receiver of the computer 14. A message is displayed instructing the agent to be within a certain proximity of the storage container (e.g., directly in front of a tank or within a predefined radius corresponding to a resolution of the GPS).

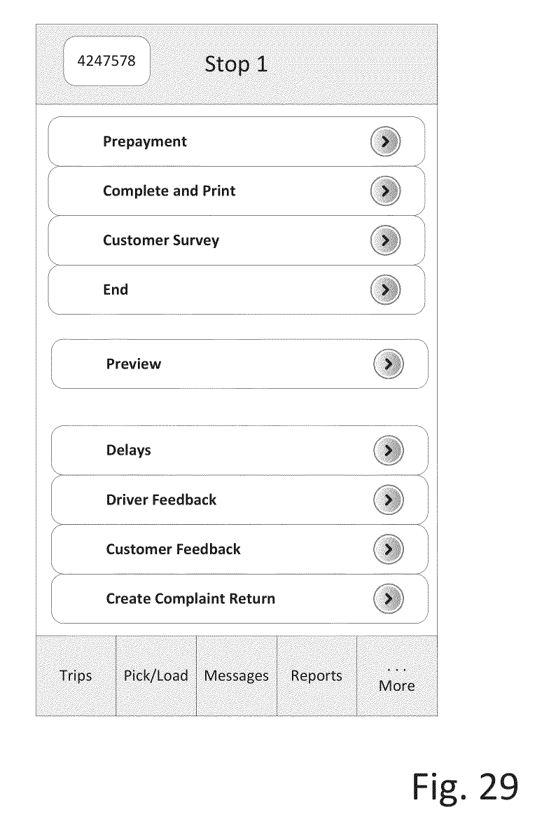

After the delivery location is confirmed, the agent may proceed with the delivery, and then an initial documentation (e.g., a delivery receipt) is generated at step 218. FIG. 29 shows an example GUI 87 by which the agent completes the delivery process. Menu options are provided for accessing payment details, obtaining responses to a customer survey, inputting delays, obtaining driver feedback, obtaining customer feedback, and initiating a complaint return process. Upon selection of the “Complete and Print” option, the delivery receipt is printed, e.g., using the printer 19, and presented to the recipient. The receipt may also be displayed on screen by selecting the “Preview” option.

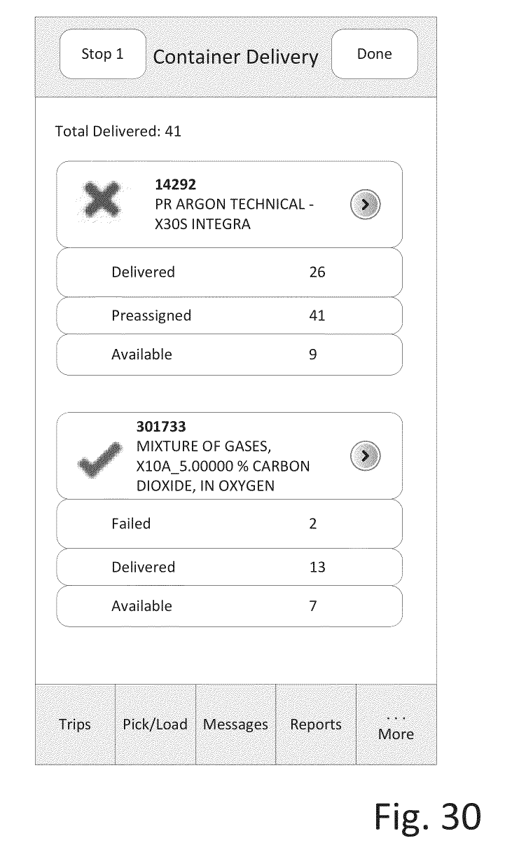

FIG. 30 shows an example GUI 88 by which details of a packaged delivery are recorded. For each product that the agent attempted to deliver, the computer 14 may display a total amount delivered, a total amount assigned for delivery, a total amount remaining in the vehicle and available for further delivery, and a total amount for which delivery was attempted but failed.

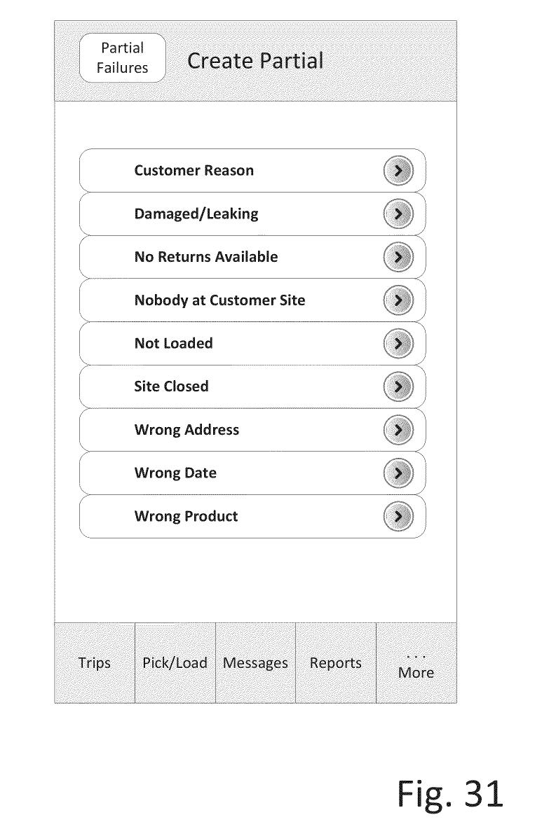

FIG. 31 shows an example GUI 89 by which the agent inputs reasons for partial delivery failures, in which the delivery was partially successful. Partial failures may arise when, e.g., a particular storage container is damaged, the delivery site for a particular product is closed, the wrong product was loaded, or delivery was attempted on the wrong date.

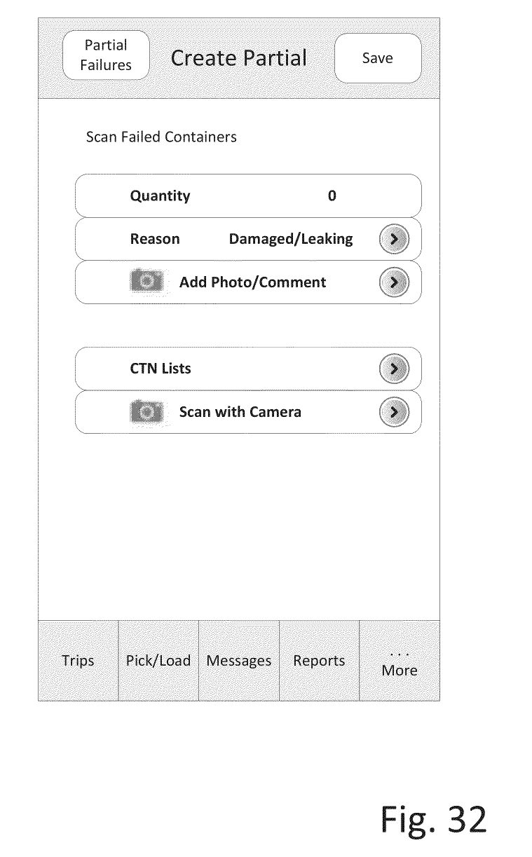

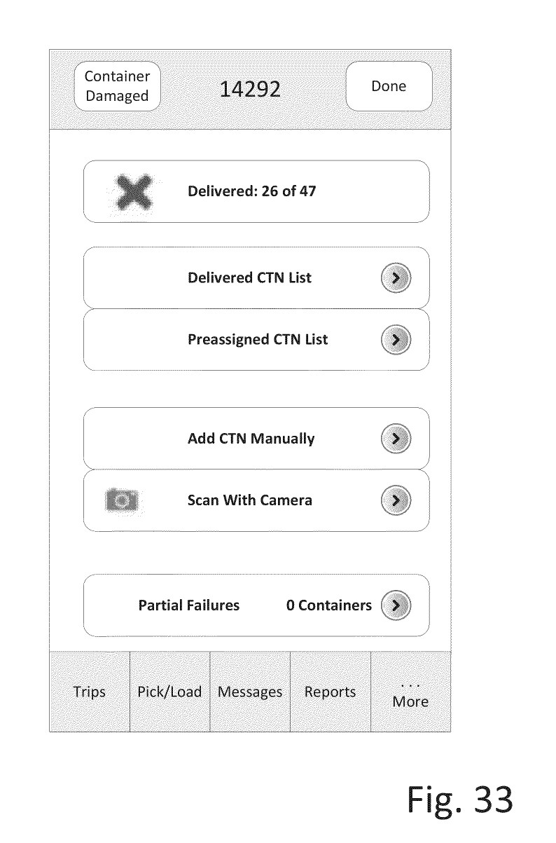

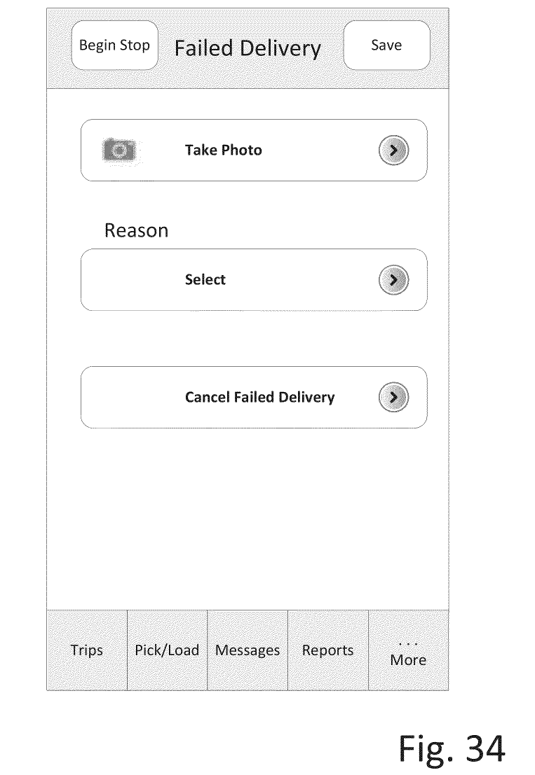

FIG. 32 shows an example GUI 90 by which failed storage containers are scanned, e.g., using the barcode technique previously described in connection with delivery location confirmation. The software transmits the scanned container codes to the server 20, along with photos of the failed containers and comments from the agent. The software may keep a list of failed containers, a list of containers for which delivery was successful, and a list of containers assigned for delivery. As shown in FIG. 33, an example GUI 91 allows the agent to access one or more of the container lists, manually input container codes, and scan containers using the camera. FIG. 34 shows an example GUI 92 that allows the agent to document delivery failure by taking a photo using the camera or inputting a failure reason. The server 20 may reschedule failed deliveries by assigning the failed portion of a delivery to another agent, or moving the delivery to a future date while keeping the same agent.

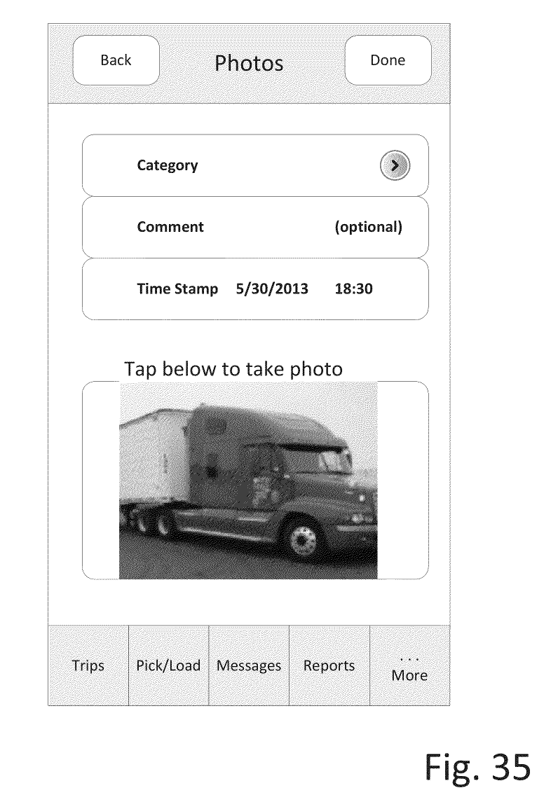

FIG. 35 shows an example GUI 93 by which photos captured using the camera are accessed. Each photo may be time-stamped and include a comment from the agent. As shown in FIG. 35, the photos are useful not only for capturing failed containers, as discussed above, but also for capturing problems with the delivery equipment. Such photos may be attached to a vehicle incident report created, e.g., using the VCR option in FIG. 8, and transmitted to the server 20 for storage.

In an example embodiment, the software prevents the delivery process from being ended until information pertaining to the stop phase has been validated. Validation may be performed at the server 20. The software may disable the “End” option in FIG. 29 until it receives an indication from the server 20 that all the information is valid. Thus, the agent may not be able to input the stop end time or save information for the stop until the information is validated. For each item of invalid information, the server 20 may cause the computer to display an error message or warning. Validation is important for maintaining accurate records of each delivery. Validation may also be performed at the computer 14.

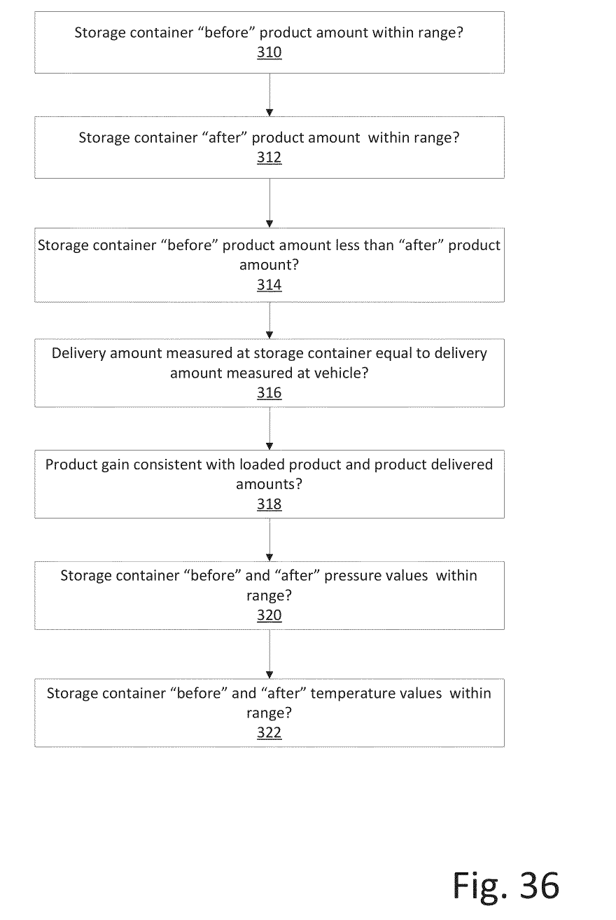

In an example embodiment, validated information is divided into the following categories: customer delivery, vehicle condition, time-stamping, and scheduling. Examples for each category are shown in FIGS. 36 to 39. In addition to information pertaining to the stop phase, information relating to the pre-trip phase, the post-trip phase, or the trip in general may also be validated. Accordingly, it will be understood that validations may occur at any time. Furthermore, the order in which the validations are performed need not be fixed (e.g., in the order shown in FIGS. 36 to 39), but may instead depend on when information becomes available to the server 20.

The system 100 may differentiate between “hard” errors and “soft” errors. Hard errors are those that, if left uncorrected, prevent a particular delivery and possibly the entire trip from being processed to completion at the server 20. Soft errors are those in which the error does not prevent complete processing. For example, if the error is quantitative, the system may treat the error as soft when the error is within a predefined tolerance range.

Example validation steps will now be described with reference to FIGS. 36 to 39. The steps should be taken as illustrative and need not be performed in the order shown. Although the steps are described in connection with validation of bulk deliveries, it will be understood that various steps may also be applied towards packaged deliveries. FIG. 36 is a flowchart of a method 300 for validating customer delivery information according to an example embodiment of the present invention. At step 310, the software determines whether the amount of product existing in the recipient's storage container prior to delivery is within a first predefined range (no error). The amount of product can be determined by sensor readings, e.g., using a try-cock valve installed in the storage container. In an example embodiment, the software may calculate the amount based on the sensor readings (e.g., a height of the product, measured in inches) and based on information about the geometry of the container (e.g., diameter, height, etc.). The sensor in the storage container may be configured to display the readings to the agent, who inputs the readings into the computer 14 for transmission to the server 20. Alternatively, the sensor may wirelessly communicate with the computer 14 to avoid manual input.

At step 312, the software determines whether the amount of product existing in the recipient's storage container after delivery is within a second predefined range (no error). This may be used to ensure a minimum level of product in each storage container. The errors in steps 310 and 312 are examples of errors that may be overridden at the election of the agent.

At step 314, the software determines whether the amount of product in the storage container before delivery is less than the amount of product after delivery (no error). This checks whether product was actually added to the storage container.

At step 316, the software determines whether the delivery amount measured at the storage container is equal to the delivery amount measured at the vehicle (no error). As mentioned earlier, the amount in the storage container can be measured using a sensor. The delivery vehicle can also be equipped with a sensor, which may or may not be the same type of sensor as that of the storage container. For example, the delivery vehicle may also have a try-cock valve sensor, in which case the delivery amount is the difference between the before and after values of the try-cock sensor. As another example, the delivery vehicle may include a flowmeter that measures the volume of product transferred (e.g., in gallons). The software may convert one or both of the sensor readings into values that can be directly compared. For example, the software may convert the storage container's sensor reading into an equivalent amount in gallons. If the difference is within a tolerance range (e.g., a fixed percentage of the amount delivered according to the vehicle's sensor), the error may be considered soft, and the software allows the agent to override the error. If the difference exceeds the tolerance range, the error may be considered hard, and the software may require the agent to correct the error (e.g., by indicating which of the sensor readings is correct or by inputting a correct delivery amount) before allowing the agent to proceed.

At step 318, the software determines whether the amount of product gained after any particular trip is consistent with the amount of product loaded and the amount of product delivered over the course of the entire trip (no error). If only deliveries were made, the gain should be negative (i.e., a loss) and approximately equal to the total amount delivered. However, if the agent made a loading stop, the gain may be positive depending on how much product was loaded after the initial loading at the beginning of the trip. The gain can be calculated, e.g., using a try-cock valve or other sensor that measures the amount stored in the delivery vehicle at the end of the trip (post-trip), which sensor may be separate from the sensor used for measuring the delivery amount at the vehicle in step 316. This determination is especially useful as a post-trip validation (e.g., during step 220 in FIG. 2), to check for errors in the delivery amounts recorded over the course of the entire trip, and to confirm that the validations in step 316 were in fact correct. For example, a net product gain or loss can be calculated for the entire trip using a post-trip measurement. The post-trip net product gain/loss may then be compared to a net product gain or loss calculated using the amounts recorded by the sensors in step 316 (e.g., the flowmeter and/or the try-cock valve in the storage container). If the post-trip net gain/loss differs from the net gain/loss calculated using the recorded delivery amounts by more than a specified tolerance threshold, the software may issue a hard error. If the difference is within the specified tolerance threshold, the software may allow the agent to override the error, e.g., by ignoring the post-trip net gain/loss and using the recorded amounts for documentation purposes.

At step 320, the software determines whether the amount of pressure in the storage container before delivery, and also after delivery, is within range (no error). The before and after pressure ranges may be the same or different, and correspond to pressures that are known to be safe for storing the product. The pressure ranges can vary depending on the type of product or the characteristics of the storage container.

At step 322, the software determines whether the temperature in the storage container before delivery, and also after delivery, is within range (no error). The before and after temperature ranges may be the same or different, and correspond to temperatures that are known to be safe for storing the product. The temperature ranges can vary depending on the type of product or the characteristics of the storage container.

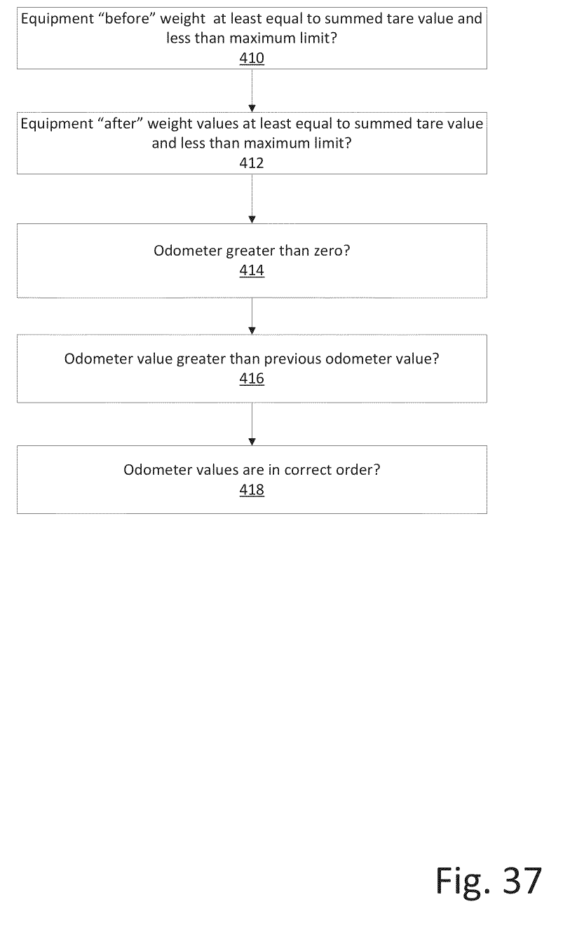

FIG. 37 is a flowchart of a method 400 for validating vehicle condition information according to an example embodiment of the present invention. At step 410, the software determines whether weight values of the delivery equipment before loading are at least equal to a summed tare value and also less than a first weight limit (no error). The total weight of the equipment should at least be equal to the sum of the tare weights (i.e., the unloaded weights) of each item of equipment measured individually. It may also be desirable to limit the pre-loading weight to the first weight limit to allow adequate room for product. The individual weights, as well as the total weight, may be measured using appropriate sensors such as strain gauges or piezoelectric sensors.

At step 412, the software determines whether weight values of the delivery equipment after loading are at least equal to the summed tare value and also less than a second weight limit (no error). The second weight limit can be a maximum weight for safely operating the equipment or a maximum weight for traveling along a particular route.

At step 414, the software determines whether the odometer is greater than zero (no error). This may be performed each time a stop is made after the odometer is reset. For example, the agent may reset the odometer at the beginning of the trip. The odometer may also be reset after each stop, in which case this determination ensures that a correct mileage is input for all stops.

At step 416, the software determines whether the current odometer value is greater than the previous odometer value (no error). The software may perform this determination for all odometer values to ensure that the odometer values are in the correct order (step 418).

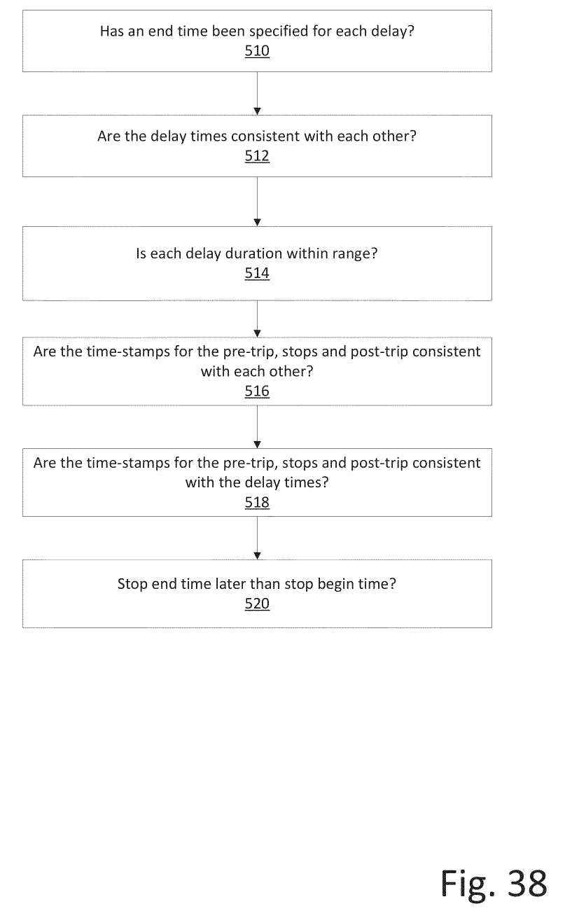

FIG. 38 is a flowchart of a method 500 for validating time-stamp information according to an example embodiment of the present invention. At step 540, the software determines whether an end time has been specified for each delay. This may be performed whenever a delay is begun, to prevent the delay from being saved without an end time.

At step 512, the software determines whether the delays times are consistent with each other (no error). For example, the software may check to make sure that no delays have overlapping times.

At step 514, the software determines whether the duration of each delay is within range (no error). There may, for example, be a limit on how long each delay can be.

At step 516, the software determines whether the time-stamps for the pre-trip, stops, and post-trip are consistent with each other (no error). This may involve comparing the time-stamps to make sure that the pre-trip occurs first, the post-trip occurs last, and the stops are in the correct order.

At step 518, the software determines whether the time-stamps for the pre-trip, stops and post-trip are consistent with the delays times (no error). This may involve making sure that the delay times do not overlap with any of the pre-trip, stops and post-trip times.

At step 520, the software determines whether each stop time is later than its respective begin time (no error).

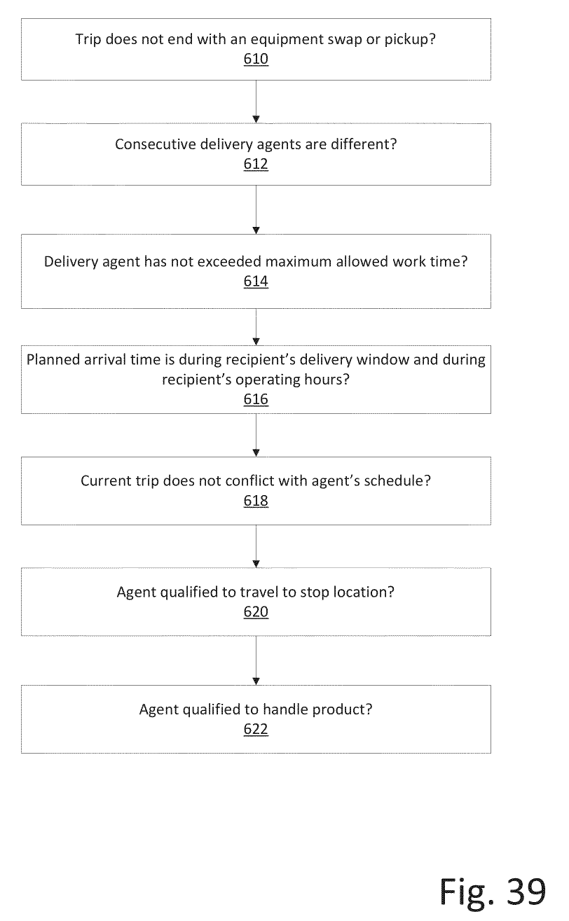

FIG. 39 is a flowchart of a method 600 for validating scheduling information according to an example embodiment of the present invention. At step 610, the software determines whether a trip does not end with an equipment swap or pickup (no error). If the trip ends with a swap or pickup, the server 20 may prevent the trip from being assigned to an agent.

At step 612, the server 20 determines whether a trip requiring more than one agent uses different agents consecutively (no error). This prevents agents from working double shifts.

At step 614, the server 20 determines whether the agent has not exceeded a maximum allowed work time (no error). For example, the Department of Transportation limits the average work week for truck drivers to a certain number of hours to ensure that drivers have adequate rest. If a trip causes the agent to exceed the maximum allowed work time, the server 20 may prevent the trip from being assigned to an agent.

At step 616, the server 20 determines whether a planned arrival time is during a recipient's delivery window and operating hours (no error).

At step 618, the server 20 determines whether the agent's schedule does not conflict with the current trip (no error). For example, the agent may have a scheduled absence that makes it impossible to complete the trip. This determination can be made whenever the current trip is modified by adding a stop.

At step 620, the server 20 determines whether the agent is qualified to travel to a stop location (no error). Agents may differ with respect to being qualified to drive along local roads, across country borders, or along different types of roads. If the agent is not qualified, the server 20 may reassign the trip, remove the stop, or suggest an alternate route to the stop.

At step 622, the server 20 determines whether the agent is qualified to handle each product loaded or scheduled for loading into the delivery vehicle (no error). Agents may differ with respect to being qualified to handle specific types of products, such as hazardous materials.

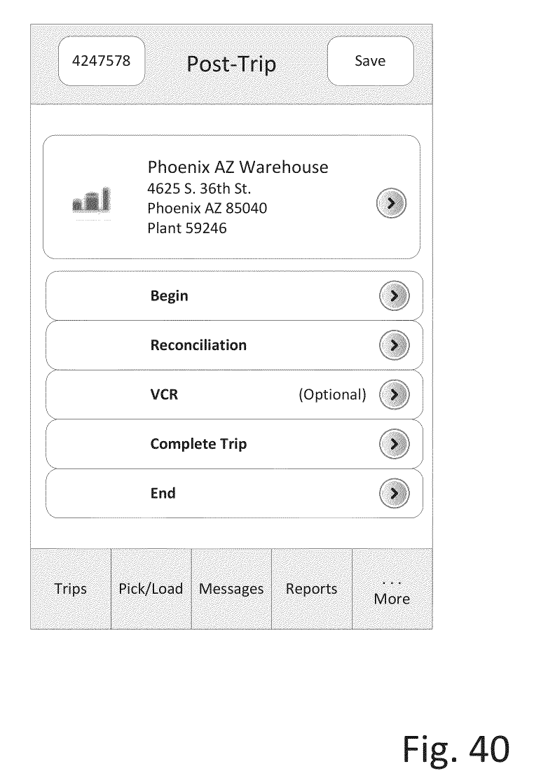

FIG. 40 shows a GUI 94 by which the agent is provided with options to begin and end the post-trip phase. The steps in FIG. 40 may be performed to implement the post-trip process in step 220 of FIG. 2. The GUI 94 includes an option to complete a vehicle condition report. The GUI 94 also includes an option to start a reconciliation process that involves one or more of the previously described validations, e.g., those that check for consistency of information among stops. In an example embodiment, the software may use the reconciliation process to repeat various validations that occurred during each delivery stop. The repetition serves as a double-check against data entry errors, and prevents data from being mistakenly changed after the initial validations have been performed. Preferably, the repeated validations are those that check for correct product amounts, especially step 316 in FIG. 36.

After performing the reconciliation process, the post-trip phase is complete and the server 20 generates final documentation, e.g., an invoice for mailing to the recipient (FIG. 2, step 222). Since the product amounts have been subjected to validation (possibly repeated validation), it is highly probable that the final documentation accurately reflects the actual delivery. Where there is inconsistency between the initial and the final documentation, the final documentation may supersede the initial documentation. The invoice may include a note explaining the inconsistency.

An example embodiment of the present invention is directed to one or more processors, which can be implemented using any conventional processing circuit and device or combination thereof, e.g., a Central Processing Unit (CPU) of a Personal Computer (PC) or other workstation processor, to execute code provided, e.g., on a hardware computer-readable medium.

An example embodiment of the present invention is directed to a non-transitory, hardware computer-readable medium, e.g., as described above, on which are stored instructions executable by a processor to perform any one or more of the methods described herein.

An example embodiment of the present invention is directed to a method, e.g., of a hardware component or machine, of transmitting instructions executable by a processor to perform any one or more of the methods described herein.

Example embodiments of the present invention are directed to one or more of the above-described methods, e.g., computer-implemented methods, alone or in combination.

In the example embodiments above, various steps were described as being performed by a processor of a computer 14 based on software instructions programmed into the computer 14, or performed by a processor of a server 20. The steps need not be assigned to the computer 14 and the server 20 exactly as described. For example, all the steps may be performed at a single computer (e.g., either the computer 14 or the server 20). Alternatively, some steps described as being performed at the computer 14 may instead be performed at the server 20 and vice versa.

The above description is intended to be illustrative, and not restrictive. Those skilled in the art can appreciate from the foregoing description that the present invention may be implemented in a variety of forms, and that the various embodiments can be implemented alone or in combination. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and appendices. Further, steps illustrated in the flowcharts may be omitted and/or certain step sequences may be altered, and, in certain instances multiple illustrated steps may be simultaneously performed.

What is claimed is:

1. A computer-implemented method for monitoring a delivery, comprising:
at a processor of a first computer, receiving delivery information from a second computer, wherein the information is transmitted in real-time during the delivery and indicates an amount of a product that was delivered; and
at the processor, updating a database to reflect the amount of the product that was delivered according to the received information.

2. The method of claim 1, wherein the delivery involves transferring the product to a storage container.

3. The method of claim 1, wherein the delivery involves transferring the product in at least one package.

4. The method of claim 1, wherein the product is one of a liquid, a gas, or a piece of equipment.

5. A computer-implemented method for monitoring a delivery, comprising:
at a processor of a computer, receiving information identifying a storage container;
at the processor, comparing the information to stored information associated with a storage container assigned to the delivery; and
based on the comparing, outputting an indication of whether the identified storage container matches the storage container assigned to the delivery.

6. The method of claim 5, wherein the information identifying the storage container is obtained from a barcode associated with the identified storage container.

7. The method of claim 5, wherein the information identifying the storage container is obtained from a Global Positioning System (GPS) receiver located near the identified storage container.

8. The method of claim 7, wherein the GPS receiver is built into the computer, which is a smartphone.

9. The method of claim 5, further comprising:
receiving information describing a delivery of a product into the identified storage container; and
at the processor, updating a database to reflect the delivery of the product when the identified storage container matches the storage container assigned to the delivery.

10. The method of claim 9, wherein the database is updated to reflect an amount of the product that was delivered into the storage container.

11. A system for monitoring a delivery, comprising:
a computer that receives information identifying a storage container;
wherein a processor of the computer is configured to perform the following:
comparing the information to stored information associated with a storage container assigned to the delivery; and
based on the comparing, outputting an indication of whether the identified storage container matches the storage container assigned to the delivery.

12. The system of claim 11, wherein the computer obtains the information identifying the storage container from a barcode associated with the identified storage container.

13. The system of claim 11, wherein the computer obtains the information identifying the storage container from a Global Positioning System (GPS) receiver located near the identified storage container.

14. A computer-implemented method for creating a delivery schedule, comprising:
at a processor of a computer, receiving a user request to create a schedule for a user-defined delivery trip;
receiving user input of a trip starting location and a trip ending location;
displaying a list of potential delivery locations at the computer; and
adding a delivery stop to the schedule between the starting location and the ending location, in response to user selection of one of the potential delivery locations.

15. The method of claim 14, further comprising:
at the processor, associating the schedule with a delivery vehicle by which a product is to be transported to the delivery stop.

16. The method of claim 14, further comprising:
at the processor, associating the delivery stop with an existing delivery order.

17. The method of claim 14, wherein the list is sorted according to distances respectively associated with each potential delivery location.

18. The method of claim 17, wherein the list is sorted according to a distance of each potential delivery location from a current location of the computer.

19. A computer-implemented method for monitoring delivery of a product, comprising:
at a processor of a computer, receiving an output of a first sensor in a storage container;
at the processor, receiving an output of a second sensor in a delivery vehicle from which the product is transferred into the storage container; and
at the processor, granting permission to end a delivery process, wherein the granting depends on an outcome of a comparison between delivery amounts indicated by the respective outputs of the first sensor and the second sensor.

20. The method of claim 19, further comprising:
at the processor, confirming, using at least one of a GPS receiver and information from an electronic tag associated with the storage container, that the storage container matches a storage container assigned to a delivery order; and
generating an error message when the storage container does not match the storage container assigned to the delivery order.

21. The method of claim 20, wherein the processor performs the confirming using the electronic tag, which is a barcode.

22. The method of claim 21, further comprising:
at the processor, capturing the barcode using a camera of the computer.

23. The method of claim 20, wherein the processor performs the confirming using the GPS receiver, which is built into the computer.

24. The method of claim 19, further comprising:
at the processor, performing the comparison by:
calculating a first delivery amount from the output of the first sensor;
calculating a second delivery amount from the output of the second sensor; and
calculating a difference between the first delivery amount and the second delivery amount; and
at the processor, refusing permission when the difference exceeds a predefined tolerance range.

25. The method of claim 24, wherein the tolerance range is a fixed percentage of the second delivery amount.

26. The method of claim 19, wherein the first sensor measures a height of the product in the storage container, and the second sensor measures a volume of product transferred from the delivery vehicle.

27. The method of claim 19, further comprising:
repeating the steps of receiving an output of a first sensor in a storage container, receiving an output of a second sensor in a delivery vehicle, and granting permission to end the delivery process, for at least one additional delivery in which the same delivery vehicle is used to transfer the product into another storage container at a different location; and
after all of the delivery processes have ended, validating delivery amounts for all of the deliveries by, at the processor:
calculating a net amount of product gained or lost by the delivery vehicle over the course of all of the deliveries, using data from a separate sensor that measures an amount of product stored in the delivery vehicle; and
comparing the net amount to a second net amount calculated using the first delivery amounts and the second delivery amounts from all of the deliveries.
